(19) United States
(12) Patent Application Publication
(10) Pub. No.: US 2025/0233135 A1
(43) Pub. Date: Jul. 17, 2025

(54) 3D POROUS SILICON ANODE ELECTRODE FOR FAST-CHARGING LITHIUM-ION BATTERY CELLS

(71) Applicant: GM GLOBAL TECHNOLOGY OPERATIONS LLC, Detroit, MI (US)

(72) Inventors: Zhe LI, Shanghai (CN); Qili SU, Shanghai (CN); Xin ZHANG, Shanghai (CN); Haijing LIU, Shanghai (CN)

(21) Appl. No.: 18/591,548

(22) Filed: Feb. 29, 2024

(30) Foreign Application Priority Data
Jan. 16, 2024 (CN) 202410065618.X

(51) Int. Cl. H01M 4/38; H01M 4/02; H01M 4/04; H01M 4/58; H01M 4/66; H01M 4/74; H01M 10/0562

(52) U.S. Cl. CPC H01M 4/386; H01M 4/0404; H01M 4/0426; H01M 4/5825; H01M 4/662; H01M 4/747; H01M 10/0562; H01M 2004/021; H01M 2004/027; H01M 2004/028; H01M 2300/0068

(57) ABSTRACT

A battery cell includes A anode electrodes, wherein each of the A anode electrodes includes a porous anode current collector and an active material layer comprising silicon deposited using physical vapor deposition (PVD) onto the porous anode current collector. The battery cell includes C cathode electrodes including a cathode current collector and a cathode active material layer arranged on the cathode current collector and S separators, where A, C and S are integers greater than one.

### CROSS-REFERENCE TO RELATED APPLICATIONS

This application claims the benefit of Chinese Patent Application No. 202410065618.X, filed on Jan. 16, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes and methods for manufacturing anode electrodes for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes A anode electrodes. Each of the A anode electrodes includes a porous anode current collector and an active material layer comprising silicon deposited using physical vapor deposition (PVD) onto the porous anode current collector. The battery cell includes C cathode electrodes include a cathode current collector and a cathode active material layer arranged on the cathode current collector and S separators, where A, C and S are integers greater than one.

In other features, the porous anode current collector is selected from a group consisting of a wire mesh current collector, a through-hole current collector, and a metal foam current collector. The porous anode current collector is made of a material selected from a group consisting of copper, stainless steel (SS), nickel (Ni), iron (Fe), and alloys thereof.

In other features, the porous anode current collector comprises a wire mesh. A first diameter of a wire of the wire mesh is in a range from 0.5 μm to 50 μm. A second diameter of the wire of the wire mesh in a direction transvers to the first diameter is in a range from 0.5 μm to 50 μm.

In other features, the active material layer has a thickness in a range from 0.001 μm to 30 μm. A pore size of the porous anode current collector is in a range from 0.2 μm to 80 μm. A porosity of the porous anode current collector is in a range from 30% to 99%.

In other features, the cathode active material layer includes cathode active material selected from a group consisting of a layered oxide (e.g., LiMe₂O), an olivine type oxide (LiMePO₄), a monoclinic type oxide (LiMe₂(PO₄)₃), a spinel type oxide (e.g., LiMe₂O₄), a tavorite represented by LiMeSO₄F or LiMePO₄F, where Me comprises a transition metal. The cathode active material layer includes cathode active material in a range from 30 wt % to 98 wt %, a solid electrolyte in a range from 1 wt % to 50 wt %, a conductive additive in a range from 1 wt % to 30 wt %, and a binder in a range from 1 wt % to 20 wt %.

In other features, the solid electrolyte is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte. The S separators are selected from a group consisting of a polyolefin-based separator, a cellulose separator, a ceramic-coated separator, and a high temperature stable separator.

A battery cell includes A anode electrodes. Each of the A anode electrodes includes a wire mesh an active material layer comprising silicon sputtered onto the wire mesh. The battery cell includes C cathode electrodes including a cathode current collector and a cathode active material layer arranged on the cathode current collector and S separators, where A, C and S are integers greater than one.

In other features, the wire mesh is made of a material selected from a group consisting of copper, stainless steel (SS), nickel (Ni), iron (Fe), and alloys thereof. A first diameter of a wire of the wire mesh is in a range from 0.5 μm to 50 μm. A second diameter of the wire of the wire mesh in a direction transvers to the first diameter is in a range from 0.5 μm to 50 μm.

In other features, the active material layer has a thickness in a range from 0.001 μm to 30 μm.

A pore size of the wire mesh is in a range from 0.2 μm to 80 μm. A porosity of the wire mesh is in a range from 30% to 99%.

In other features, the cathode active material layer includes cathode active material in a range from 30 wt % to 98 wt %, a solid electrolyte in a range from 1 wt % to 50 wt %, a conductive additive in a range from 1 wt % to 30 wt %, and a binder in a range from 1 wt % to 20 wt %. The cathode active material layer includes cathode active material selected from a group consisting of a layered oxide (e.g., LiMe₂O), an olivine type oxide (LiMePO₄), a monoclinic type oxide (LiMe₂(PO₄)₃), a spinel type oxide (e.g., LiMe₂O₄), a tavorite represented by LiMeSO₄F or LiMePO₄F, where Me comprises a transition metal.

In other features, the solid electrolyte is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte. The S separators are selected from a group consisting of a polyolefin-based separator, a cellulose separator, a ceramic-coated separator, and a high temperature stable separator.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including A anode electrodes, C cathode electrodes, and S separators according to the present disclosure;

FIG. 2 is a side view of an example of an anode electrode, a cathode electrode, and a separator;

FIG. 3A is a scanning electron microscope image of an example of a planar silicon anode on a stainless steel current collector;

FIG. 3B is a graph illustrating an example of charge voltage as a function of state of charge percentage (SOC %) for the battery cell of FIGS. 2 and 3A at different charging rates;

FIG. 4A is an enlarged plan view of an example of an anode electrode including a porous current collector that is coated with silicon using physical vapor deposition (PVD) according to the present disclosure;

FIG. 4B is a side cross sectional view of an example an anode electrode including a porous current collector that is coated with a silicon layer using physical vapor deposition (PVD) according to the present disclosure;

FIG. 5 is a functional block diagram of an example of a magnetron for sputtering the silicon layer onto the porous current collector according to the present disclosure;

FIG. 6 is a side cross sectional view of an example of a battery cell including an anode electrode, a cathode electrode, a separator, and a liquid electrolyte according to the present disclosure;

FIG. 7 is a side cross sectional view of an example of a solid-state battery cell including an anode electrode, a cathode electrode, a separator, and a solid-state electrolyte according to the present disclosure;

FIGS. 8 and 9 are scanning electron microscope images of an example of a porous anode current collector with a silicon layer according to the present disclosure;

FIG. 10 is a graph showing an example of an X-ray diffraction (XRD) profile for a porous anode current collector and a porous silicon anode electrode according to the present disclosure;

FIG. 11 is a graph showing an example of a Raman spectrum for a porous silicon anode electrode according to the present disclosure;

FIG. 12A is a graph illustrating an example of voltage as a function of SOC % for a planar silicon anode electrode and a porous silicon anode electrode according to the present disclosure; and

FIG. 12B is a graph illustrating an example of SOC % as a function of time for a planar silicon anode electrode and a porous silicon anode electrode according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Anode electrodes using silicon as the anode active material are a promising alternative to anode electrodes using graphite. Silicon is environmentally benign and has a reasonable electrochemical potential (−0.3 V vs Li/Li+) and a high theoretical capacity (4200 mAh/g for Li44 Si). Although silicon anode electrodes provide multiple lithiation and de-lithiation pathways during battery cycling, silicon is not an optimal anode active material for fast charging. Planar silicon anode electrodes suffer from a low intrinsic electrical conductivity at room temperature (<10⁻⁵ Siem/cm), which will deteriorate battery rate performance and prevent fast-charging usage.

The present disclosure relates to a porous silicon anode electrode including a porous anode current collector with a PVD-deposited silicon layer. In some examples, a uniform silicon anode active material is PVD-deposited onto a 3D copper mesh current collector to enable fast charging. The 3D copper mesh of the anode electrode provides an effective electronic conduction network to create fast electronic transport pathways. The porous structure of the 3D copper mesh provides sufficient space for electrolyte to facilitate lithium-ion transport while accommodating silicon volume change during cycling. The deposited amorphous Si layer is binder-free and can reduce the internal resistance of the battery cell. As a result, the porous silicon anode electrode enables enhanced fast-charging capability.

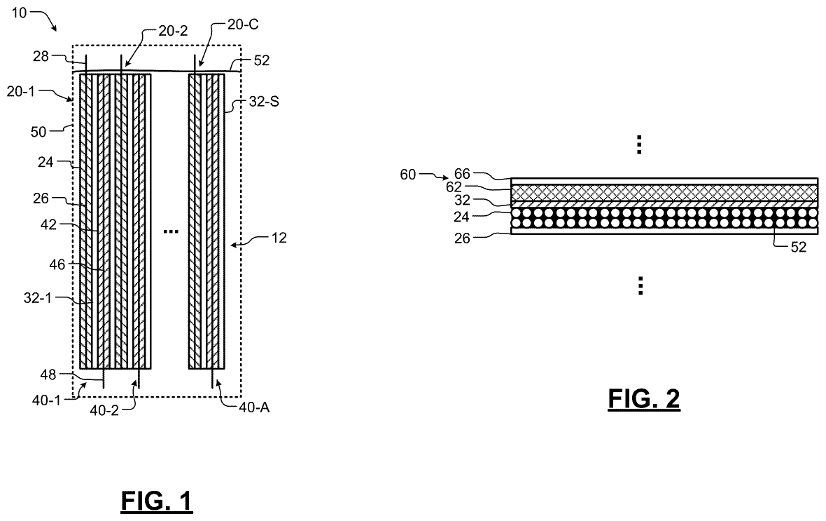

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26. The A anode electrodes 40-1, 40-2, . . . , and 40-A include anode active material layers 42 arranged on an anode current collector 46. In some examples, the A anode electrodes 40 and the C cathode electrodes 20 exchange lithium ions during charging/discharging.

In some examples, the anode active material layer 42 includes a silicon layer PVD-deposited onto the anode current collector 46. The anode current collector 46 comprises a porous current collector such as a wire mesh current collector, a through-hole current collector (e.g., foil with holes), a metal foam current collector, and/or other high-porosity current collector material. In some examples, the cathode active material layers 24 comprise coatings including one or more active materials, one or more conductive additives, and/or one or more binder materials that are applied (cast or laminated) onto the current collectors.

In some examples, the cathode current collector 26 comprises metal foil, metal mesh, perforated metal, 3 dimensional (3D) metal foam, and/or expanded metal. In some examples, the cathode current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells. In some examples, the battery cell 10 uses liquid electrolyte 52. In other examples, the separator 32 and the cathode active material layer 24 include solid-solid electrolyte, a gel electrolyte, and/or liquid electrolyte.

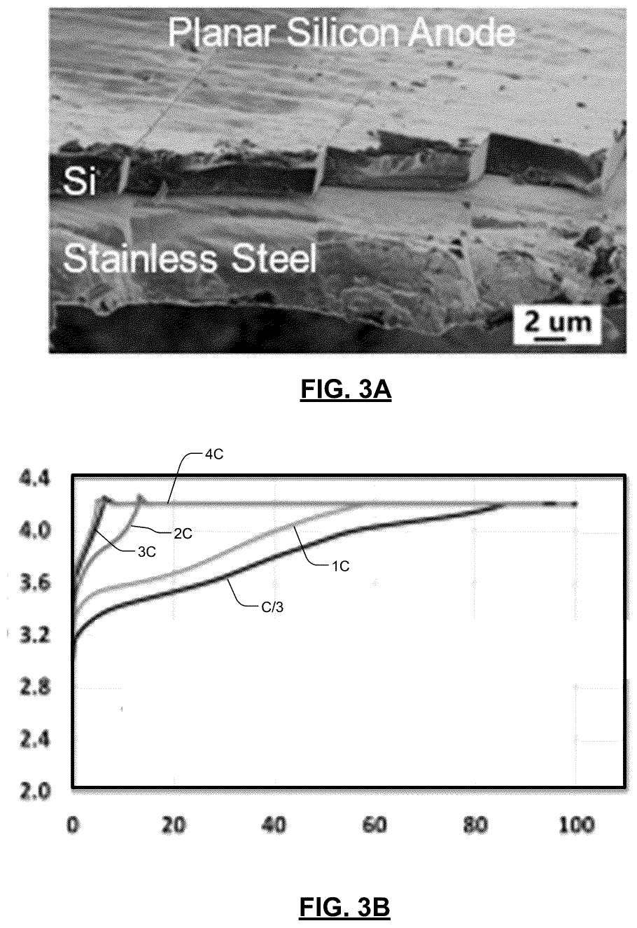

Referring now to FIGS. 2 to 3B, an anode electrode 60 includes a planar silicon anode active material 62 deposited on a planar current collector 66 such as stainless steel. In FIG. 3A, a scanning electron microscope image of the anode electrode 60 is shown. In FIG. 3B, charge voltage of the anode electrode 60 is shown as a function of state of charge percentage (SOC %) for different charging rates (C/3, 1C, 2C, 3C, and 4C). The separator 32 comprises a polymer separator and the liquid electrolyte 52 is used. As can be appreciated, the anode electrode 60 is dense and does not allow sufficient space to buffer expansion of the silicon. Silicon is a semiconductor and has a low electrical conductivity at room temperature (<10⁻⁵ Siem/cm). As can be appreciated, ineffective electronic transport pathways lead to poor fast-charging capability.

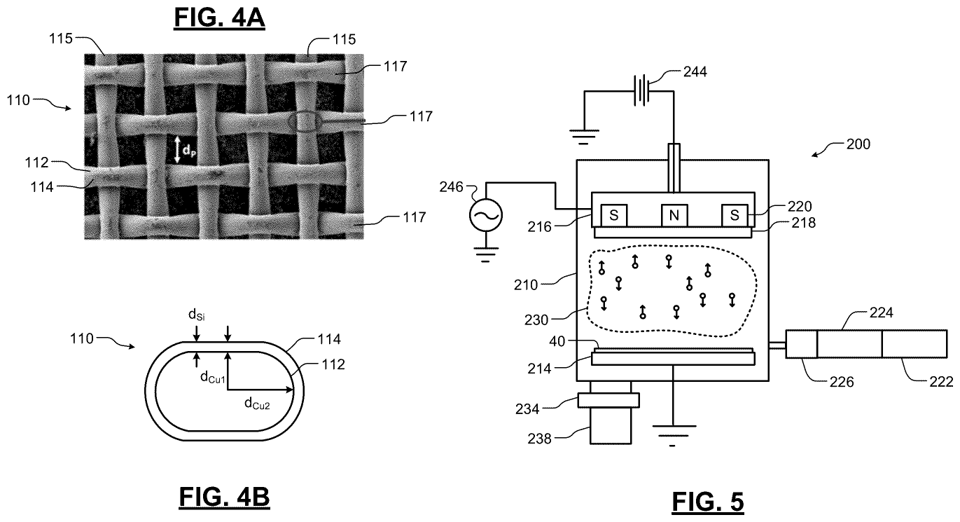

Referring now to FIGS. 4A and 4B, an anode electrode 110 according to the present disclosure is shown to include a porous anode current collector 112 and an anode active material layer 114 including silicon. The silicon is PVD-deposited onto the porous anode current collector 112 using a magnetron sputtering approach. In FIG. 4B, the porous anode current collector 112 includes first and second sets of wires 115 and 117 that cross one another at a predetermined angle (e.g., transverse) and are interwoven. The wires of the first and second sets of wires have a first diameter d_{Cu1} and a second diameter d_{Cu2} transverse to the first diameter d_{Cu1}. The anode active material layer 114 is deposited onto the porous anode current collector 112 with a thickness d_{Si}. Spacing between adjacent wires of the porous anode current collector 112 is equal to dₚ.

In some examples, d_{Cu1} is in a range from 0.5 μm to 50 μm. In other examples, d_{Cu1} is in a range from 1 μm to 30 μm. In some examples, d_{Cu2} is in a range from 0.5 μm to 50 μm. In other examples, d_{Cu2} is in a range from 1 μm to 30 μm. In some examples, the porous anode current collector 112 is made of a material selected from a group consisting of copper, stainless steel (SS), nickel (Ni), iron (Fe), alloys of these materials, and/or other conductive materials.

In some examples, the thickness d_{Si} of the anode active material layer 114 is in a range from 0.001 μm to 30 μm. In some examples, the thickness d_{Si} of the anode active material layer 114 is in a range from 0.05 μm to 20 μm. In some examples, areal capacity loading of the anode active material layer 114 is in a range from 0.5 mAh/cm² to 20 mAh/cm². In other examples, areal capacity loading of the anode active material layer 114 is in a range from 3 mAh/cm² to 10 mAh/cm².

In some examples, spacing between the wires (or pore size) dₚ is in a range from 0.2 μm to 80 μm. In other examples, spacing (or pore size) dₚ is in a range from 5 μm to 50 μm. In some examples, porosity is in a range from 30% to 99%. In other examples, porosity is in a range from 70% to 99%. In other examples, the mesh current collector can be replaced by through-hole, foam, and other high-porosity current collector material.

In some examples, the wire mesh current collector is used and provides an effective electronic conduction network and uniform electric field distribution to create pathways for fast electron transport in the silicon-based anode electrode. The anode electrode provides sufficient porous space for the liquid electrolyte to facilitate lithium-ion transport and a shortened ion diffusion path. The porous space is also provided to accommodate the volumetric change of the silicon during lithiation and de-lithiation. The deposited silicon active material provides a uniform and amorphous Si layer to enable a good cell cycling performance. The active material layer does not include an insulating polymer binder that may increase the internal resistance. As a result, the porous silicon anode electrode is more conductive which enhances fast-charging capability of the battery cell.

Referring now to FIG. 5, a DC magnetron sputtering device 200 deposits the anode active material layer 42 onto the porous anode current collector 112. The porous anode current collector 112 is arranged on a substrate support 214 in a processing chamber 210. A magnetron cathode 216 including magnets 220 and a target 218 is arranged spaced from the substrate support 214.

During deposition, a process gas mixture such as argon (Ar) from a gas source 222 is introduced into the processing chamber 210 while AC and/or DC power is supplied. In some examples, a mass flow controller 224 and a valve 226 are used to meter the process gas from the gas source 222 into the processing chamber 210. A throttle valve 234 and/or pump 238 control pressure within the processing chamber 210 and/or evacuate reactants from the processing chamber 210. A DC source 244 supplies DC voltage to the magnetron cathode 216. An AC source 246 supplies AC voltage to the magnetron cathode 216.

During deposition, a target material (e.g., silicon) is ejected from the target 218 and deposited on the porous anode current collector 112. Material is also sputtered from an exposed surface of the porous anode current collector 112. In some examples, a silicon target (e.g., n-type; 99.995%) sputters silicon particles onto a porous anode current collector (e.g., copper mesh). In some examples, the DC source 244 supplies DC voltage in a range from 200V to 800V. In some examples, cathode power from the AC source 246 is in a range from 2 to 30 kW at a frequency in a range from 20 to 200 kHz. In some examples, a deposition period is in a range from 20 to 840 minutes

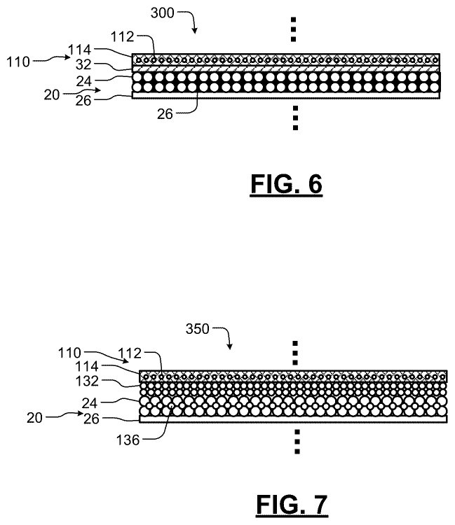

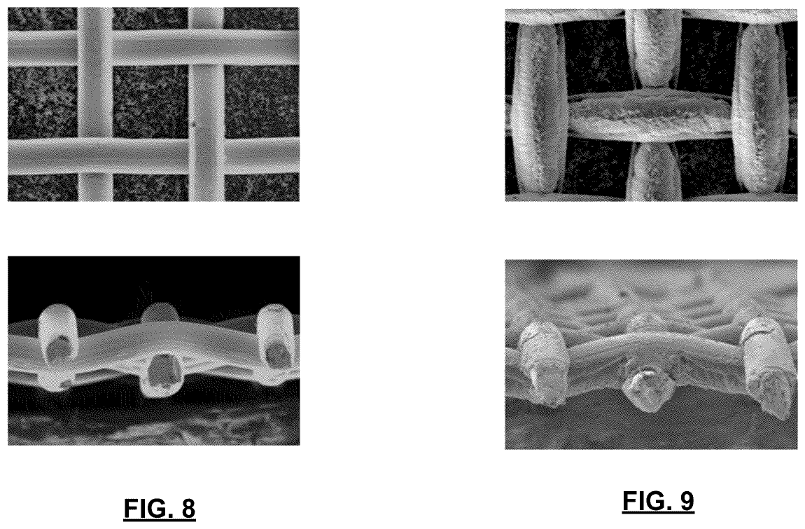

Referring now to FIGS. 6 and 7, examples of the battery cell including the porous anode electrode is shown. In FIG. 6, a liquid electrolyte-based battery cell 300 is shown. The liquid electrolyte-based battery cell 300 includes the anode electrode 110, the separator 32 (e.g., a polymer separator), the cathode electrode 20 including cathode active material layer 24, and the liquid electrolyte 52 (e.g., LiPF₆ in carbonate).

In FIG. 7, a solid-state or semi-solid-state battery cell 350 is shown. The battery cell 350 includes the anode electrode 110, the separator 132 (e.g., solid-state electrolyte layer), and the cathode electrode 20. The cathode electrode 20 includes the cathode active material layer 24 and a solid electrolyte 136. In some examples, the battery cell 350 is a solid-state battery cell. In other examples, liquid electrolyte or gel electrolyte can be used to enhance power capability.

In some examples, the cathode electrode includes the cathode active material in a range from 30 wt % to 98 wt %, the solid electrolyte in a range from 0 wt % to 50 wt %, the conductive additive in a range from 0 wt % to 30 wt %, and the binder in a range from 0 wt % to 20 wt %.

In some examples the cathode active material is selected from a group consisting of a layered oxide (e.g., LiMe₂O), an olivine type oxide (LiMePO₄), a monoclinic type oxide (LiMe₂(PO₄)₃), a spinel type oxide (e.g., LiMe₂O₄), a tavorite represented by LiMeSO₄F or LiMePO₄F where Me is a transition metal.

In some examples, the conductive additive is selected from a group consisting of carbon black, graphite, graphene, graphene oxide, Super P, acetylene black, carbon nanofibers, carbon nanotubes and other electronically conductive additives.

In some examples, the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-autadiene rubber (SBR), nitrile butadiene rubber (NBR), styrene ethylene butylene styrene copolymer (SEBS), and combinations thereof.

In some examples, the separator used for liquid electrolyte-based battery cells includes a polyolefin-based separator, a cellulose separator, a ceramic-coated separator, and a high temperature stable separator. In some examples, the liquid electrolyte wets the 5% to 100% porosity of the separator (e.g., 90%).

Examples, of polyolefin-based separators include polyacetylene: polypropylene (PP), polyethylene (PE), dual layer type (PP/PE), three layer type (PP/PE/PP). Examples of cellulose separators include polyvinylidene fluoride (PVDF) membrane and porous polyimide membrane. Examples of ceramic-coated separators include SiOx-coated PE. Examples of high-temp-stable separators include polyimide (PI) nanofiber-based nonwovens, nano-sized Al₂O₃ and poly(lithium 4-styrenesulfonate)-coated polyethylene membrane, Si-coated polyethylene (PE) separator, cepolyimide-coated polyethylene separators, polyetherimides (PEI) (bisphenol-aceton diphthalic anhydride (BPADA) and para-phenylenediamine) separator, expanded polytetrafluoroethylene reinforced polyvinylidenefluoride-hexafluoropropylene separator, sandwich-structured PVdF/PMIA/PVdF nanofibrous separators, and so on.

In some examples, the solid electrolyte is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

Examples of oxide-based solid electrolyte include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃), and LISICON type (e.g., Li₂₊₂ₓZn₁₋ₓ GeO₄).

Examples of metal-doped or aliovalent-substituted oxide solid electrolyte include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and Al-substituted perovskite, Li_{1+x+y}AlₓTi₂₋ₓSi_{y}P_{3-y}O₁₂.

Examples of sulfide-based solid electrolyte include Li₂S—P₂S₅ system, Li₂S—P₂S₅-MO_{X} system, Li₂S—P₂S₅-MSₓ sysytem, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X═Cl, Br, or I), Li_{9.54}Si_{1.74}P_{1.44}S_{11.7}Cl_{0.3}(25 mS/cm), Li_{9.6}P₃S₁₂, Li₇P₃S₁₁, Li₉P₃S₉O₃,Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.166}S₄, LiI—Li₄SnS₄, and Li₄SnS₄.

Examples of nitride-based solid electrolyte include Li₃N, Li₇PN₄, and LiSi₂N₃. Examples of hydride-based solid electrolyte include LiBH₄, LiBH₄—LiX (X═Cl, Br, or I), LiNH₂, Li₂NH, LiBH₄—LiNH₂, and Li₃AlH₆. Examples of halide-based solid electrolyte include LiI, Li₃InCl₆, Li₂CdCl₄, Li₂MgCl₄, Li₂CdI₄, Li₂ZnI₄, and Li₃OcI. Examples of borate-based solid electrolyte include Li₂B₄O₇ and Li₂O—B₂O₃—P₂O₅.

Referring now to FIGS. 8 and 9, scanning electron microscope images show a porous current collector before (FIG. 8) and after (FIG. 9) sputtering of the silicon layer onto the current collector. As can be seen, sputtering of the silicon layer does not impact the 3D porous structure of the current collector.

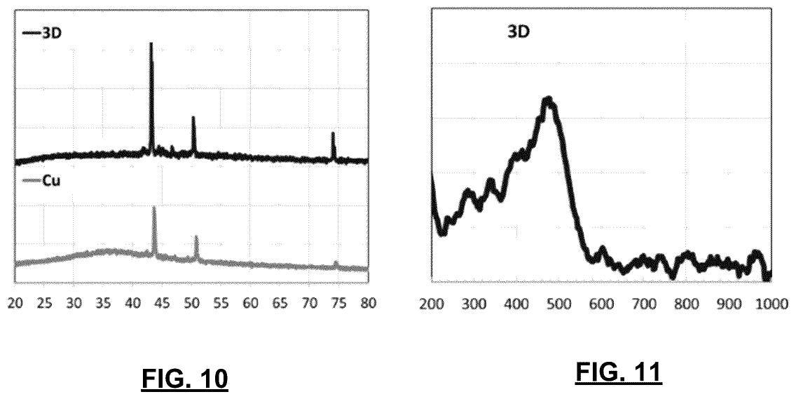

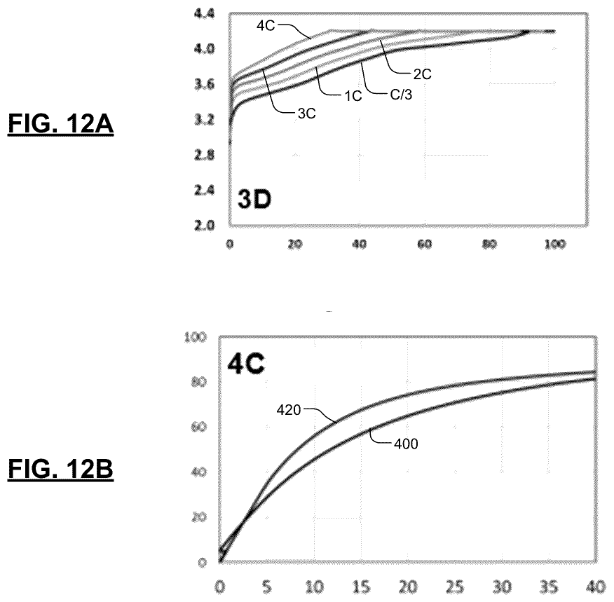

Referring now to FIGS. 10 and 11, X-ray diffraction (XRD) and Raman analysis of the porous 3D silicon anode electrode are shown. In FIG. 10, the 3D porous silicon anode electrode is amorphous with no XRD diffraction peaks corresponding to silicon. In FIG. 11, the main peak at 475 cm⁻¹ can be assigned to the transverse optical (TO) mode of amorphous silicon (a-Si).

Referring now to FIGS. 12A to 12C, fast charging performance of the porous silicon anode electrode is shown. In FIGS. 12A and 12B, voltage is shown as a function of state of charge (SOC %) at 25° C. In FIG. 12C, SOC % is shown as a function of time for a porous silicon anode electrode at 420 and a planar silicon anode electrode at 400. As can be seen, the porous anode electrode delivers improved fast-charging capability.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
A anode electrodes, wherein each of the A anode electrodes includes:
a porous anode current collector; and
an active material layer comprising silicon deposited using physical vapor deposition (PVD) onto the porous anode current collector;
C cathode electrodes including a cathode current collector and a cathode active material layer arranged on the cathode current collector; and
S separators, where A, C and S are integers greater than one.

2. The battery cell of claim 1, wherein the porous anode current collector is selected from a group consisting of a wire mesh current collector, a through-hole current collector, and a metal foam current collector.

3. The battery cell of claim 1, wherein the porous anode current collector is made of a material selected from a group consisting of copper, stainless steel (SS), nickel (Ni), iron (Fe), and alloys thereof.

4. The battery cell of claim 1, wherein:
the porous anode current collector comprises a wire mesh; and
a first diameter of a wire of the wire mesh is in a range from 0.5 μm to 50 μm, and
a second diameter of the wire of the wire mesh in a direction transvers to the first diameter is in a range from 0.5 μm to 50 μm.

5. The battery cell of claim 1, wherein the active material layer has a thickness in a range from 0.001 μm to 30 μm.

6. The battery cell of claim 1, wherein a pore size of the porous anode current collector is in a range from 0.2 μm to 80 μm.

7. The battery cell of claim 1, wherein a porosity of the porous anode current collector is in a range from 30% to 99%.

8. The battery cell of claim 1, wherein the cathode active material layer includes cathode active material selected from a group consisting of a layered oxide (e.g., LiMe₂O), an olivine type oxide (LiMePO₄), a monoclinic type oxide (LiMe₂(PO₄)₃), a spinel type oxide (e.g., LiMe₂O₄), a tavorite represented by LiMeSO₄F or LiMePO₄F, where Me comprises a transition metal.

9. The battery cell of claim 1, wherein the cathode active material layer includes cathode active material in a range from 30 wt % to 98 wt %, a solid electrolyte in a range from 1 wt % to 50 wt %, a conductive additive in a range from 1 wt % to 30 wt %, and a binder in a range from 1 wt % to 20 wt %.

10. The battery cell of claim 9, wherein the solid electrolyte is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

11. The battery cell of claim 1, wherein the S separators are selected from a group consisting of a polyolefin-based separator, a cellulose separator, a ceramic-coated separator, and a high temperature stable separator.

12. A battery cell comprising:
A anode electrodes, wherein each of the A anode electrodes includes:
a wire mesh; and
an active material layer comprising silicon sputtered onto the wire mesh;
C cathode electrodes including a cathode current collector and a cathode active material layer arranged on the cathode current collector; and
S separators, where A, C and S are integers greater than one.

13. The battery cell of claim 12, wherein the wire mesh is made of a material selected from a group consisting of copper, stainless steel (SS), nickel (Ni), iron (Fe), and alloys thereof.

14. The battery cell of claim 12, wherein:
a first diameter of a wire of the wire mesh is in a range from 0.5 μm to 50 μm, and
a second diameter of the wire of the wire mesh in a direction transvers to the first diameter is in a range from 0.5 μm to 50 μm.

15. The battery cell of claim 12, wherein the active material layer has a thickness in a range from 0.001 μm to 30 μm.

16. The battery cell of claim 12, wherein a pore size of the wire mesh is in a range from 0.2 μm to 80 μm.

17. The battery cell of claim 12, wherein a porosity of the wire mesh is in a range from 30% to 99%.

18. The battery cell of claim 12, wherein:
the cathode active material layer includes cathode active material in a range from 30 wt % to 98 wt %, a solid electrolyte in a range from 1 wt % to 50 wt %, a conductive additive in a range from 1 wt % to 30 wt %, and a binder in a range from 1 wt % to 20 wt %; and
the cathode active material layer includes cathode active material selected from a group consisting of a layered oxide (e.g., LiMe₂O), an olivine type oxide (LiMePO₄), a monoclinic type oxide (LiMe₂(PO₄)₃), a spinel type oxide (e.g., LiMe₂O₄), a tavorite represented by LiMeSO₄F or LiMePO₄F, where Me comprises a transition metal.

19. The battery cell of claim 18, wherein the solid electrolyte is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

20. The battery cell of claim 12, wherein the S separators are selected from a group consisting of a polyolefin-based separator, a cellulose separator, a ceramic-coated separator, and a high temperature stable separator.
